(19) United States
(12) Patent Application Publication
(10) Pub. No.: US 2014/0327599 A1
(43) Pub. Date: Nov. 6, 2014

(54) METHOD AND SYSTEM OF SHARING SCREEN DATA WITH A REMOTE STATION

(71) Applicant: Salman Khezae ABU AWAD, Golan Heights (IL)

(72) Inventor: Salman Khezae ABU AWAD, Golan Heights (IL)

(21) Appl. No.: 14/266,981

(22) Filed: May 1, 2014

Related U.S. Application Data
(60) Provisional application No. 61/818,921, filed on May 3, 2013.

(51) Int. Cl. G06F 3/14

(52) U.S. Cl. CPC G06F 3/1454
USPC 345/1.2

(57) ABSTRACT

A system of sharing screen data, which comprises a remote sharing unit adapted to capture screen data generated by a computer system and to communicate with a mobile device for transmitting the captured screen data to the mobile device. A dedicated application resides on the mobile device that is adapted to communicate with the remote sharing unit and with a remote station, wherein the dedicated application is adapted to receive the screen data and to send the received screen data to the remote station.

### FIELD OF THE INVENTION

The present invention relates to the field of screen sharing. More particularly, the invention relates to a method and system of sharing screen data of a local display device with a remote station (e.g., during a collaborative on-line session with a support center) by establishing a communication process that will allow communication between local computer monitor, TV screen or any other display device and a mobile device, or any device that can receive and transmit signals, in order to transfer screen data from the local screen, via the mobile device to the remote station (e.g., a support center that located in a different location).

### BACKGROUND OF THE INVENTION

Desktop or screen sharing enables an entity to view data, as displayed on a local monitor, on a remote device (e.g., a remote computer station) over a network. This allows a geographically disparate entity to view images and information over a network as if they were sitting in front of the local monitor.

The current situation is that when a computer user needs technical support, or any other support, from a support center, the user calls a support person and during the phone conversation the support center person tries to identify the problem. In many cases, the support center person communicates with the computer directly in order to view the screen and identify the problem, and fix it. There are many methods to remotely connect and take control over the user computer in order to allow the support person to be able to see the user's screen. However, such methods usually take few minutes that during this time the support person will try to identify the problem via the phone and another few minutes to take control on the user computer in order to see the user's screen.

It is an object of the present invention to provide a system which is capable of allowing the support person to view the user's screen at the same time he receives the phone call from the user.

It is another object of the present invention to provide a system which is capable of immediately presenting the current screen image to the support person, without requiring any control taking tasks over the user's computer by the support person.

It is yet another object of the present invention to provide a system which is capable of saving time in identifying the problem in the user's computer.

It is still an object of the present invention to provide a system which is capable of broadcasting screen data specific to a display device to a support center in an efficient way.

Other objects and advantages of the invention will become apparent as the description proceeds.

### SUMMARY OF THE INVENTION

The present invention provides a novel solution for direct, or indirect, communication between a feed of output images to a display device (e.g., the current screen as generated by a personal computer, in particular, a graphic adapter of that personal computer) and a remote station at a support center. The communication is done via a mobile device that the user uses in order to communicate with the support center, wherein the mobile device is adapted to transmit the current screen data, during a phone call, or during the communication method being applied between the user and the support center.

The present invention relates to a system of sharing screen data, comprising: a remote sharing unit adapted to capture screen data generated by a computer system and to communicate with a mobile device for transmitting said captured screen data to the mobile device.

According to an embodiment of the present invention, the system further comprises a dedicated application resides on the mobile device that is adapted to communicate with the remote sharing unit and with a remote station, wherein said dedicated application is adapted to receive said screen data and to send said received screen data to the remote station.

According to an embodiment of the present invention, the remote station is adapted to display the screen data received from the mobile device.

According to an embodiment of the present invention, the dedicated application is adapted to send the received screen data to the remote station during a phone call, or any other communication method, thereby allowing a person operating said remote station to view the screen data as captured by the remote sharing unit at the same time when accepting the phone call and during the phone conversation.

According to an embodiment of the present invention, the remote sharing unit is integrated within a display device. Alternatively, the remote sharing unit is integrated within a computer system, a smartphone or any other similar device or system.

According to an embodiment of the present invention, the remote sharing unit configured to operate as a splitter that receives the screen data in a video input port and splits the received screen data into two video output ports, wherein one output port is adapted to forward the screen data to the display device and the other output port is adapted to transmit the screen data to the mobile device. The remote sharing unit can be added to a computer graphic adapter (e.g., video card) or to the display device (e.g., a computer monitor) itself.

According to an embodiment of the present invention, the remote sharing unit and the mobile device communicate via a wired or wireless manner.

In another aspect, the present invention relates to a method of sharing screen data, comprising: a) Communicating with a remote sharing unit adapted to capture screen data generated by a computer system; and b) Receiving screen data transmitted from to the remote sharing unit.

According to an embodiment of the present invention, the method further comprises communicating with a remote station for sending the received screen data to the remote station, wherein said remote station is adapted to display said screen data.

According to an embodiment of the present invention, the method further comprises allowing sending the screen data to the remote station upon demand.

In another aspect, the present invention relates to a system, comprising: a) at least one processor; and b) a memory comprising computer-readable instructions which when executed by the at least one processor causes the processor to execute a dedicated application, wherein the dedicated application:
communicates with a remote sharing unit operated to transmit screen data;
receives screen data transmitted from said remote sharing unit; and
upon demand, sends the screen data to a remote station.

The present invention further relates to a non-transitory computer-readable medium comprising instructions which when executed by at least one processor causes the processor to perform the method of the present invention.

### BRIEF DESCRIPTION OF THE DRAWINGS

In the drawings:

FIG. 1 schematically illustrates a system of sharing screen data with a remote station, according to an embodiment of the invention;

FIG. 2 schematically illustrates an implementation of a remote sharing unit between a display device and a computer system, according to an embodiment of the invention.

### DETAILED DESCRIPTION OF THE INVENTION

Throughout this description the term “display device” is used to indicate an electronic visual display for presentation of images transmitted electronically. This term does not imply any particular display device, and invention is applicable to all suitable devices such as television sets, computer monitors, and the like. The display device can be applied as a standalone display or as an integrated part of a computer system (e.g., an all-in-one desktop computer that integrates the system's internal components into the same case as the display).

The terms “mobile computing device” or shortly “mobile device” refers herein to a portable information communication technology device such as a smartphone or any other device that stresses the role of unified communications (i.e., real-time and non-real-time communication services, such as messaging, telephony, data sharing, etc.) and the integration of telecommunications (telephone lines and wireless signals), computers as well as necessary enterprise software, middleware, storage, and audio-visual systems, which enable users to access, store, transmit, and manipulate information.

Reference will now be made to several embodiments of the present invention, examples of which are illustrated in the accompanying figures, where various embodiments may be generally directed to desktop and/or screen sharing systems. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The following discussion is intended to provide a brief, general description of a suitable computing environment in which the invention may be implemented. While certain examples refers herein to a Personal Computer (PC) system, other computer or electronic systems can be used as well, such as, without limitation, television set, game console, and so on.

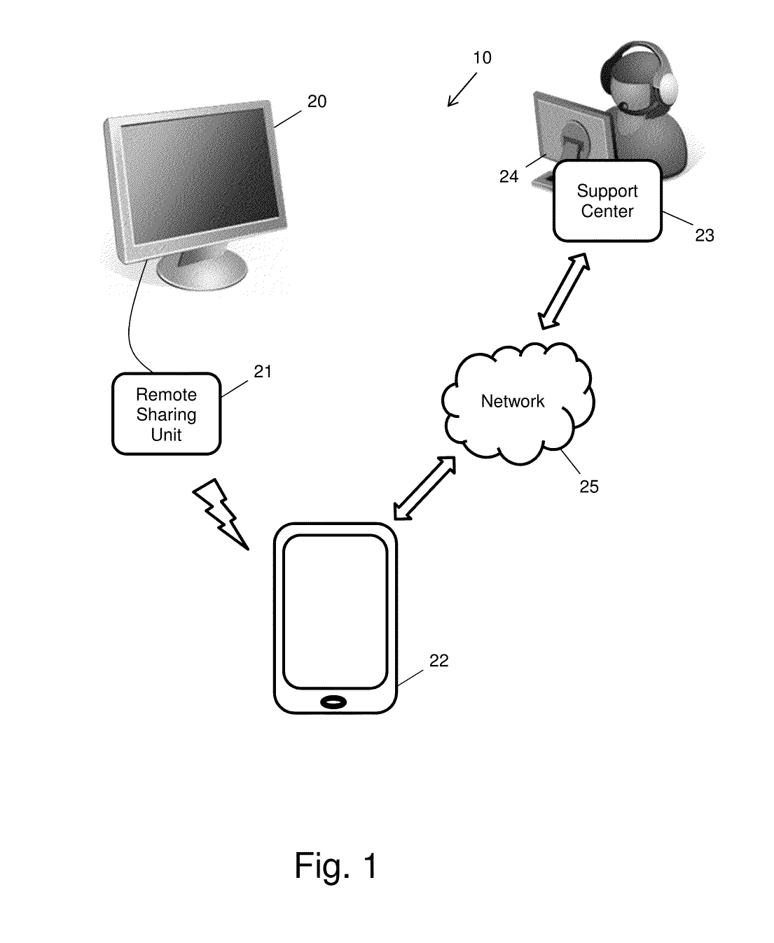

FIG. 1 schematically illustrates a system 10 of sharing screen data with a remote station, according to an embodiment of the present invention. The system comprises a display device 20, a remote sharing unit 21, a mobile device 22 and a support center 23.

The display device 20 displays feed of output images (i.e., screen data) as received from a computer system (not shown). Usually, the computer system includes a graphic adapter that generates the feed of output images to the display device 20. In common computer systems, the display device 20 is contented (e.g., via a cable) to the video out connector of the computer system (e.g., this can typical video out connector such as VGA and DVI). The remote sharing unit 21 is adapted to capture the screen data and wirelessly transmit the screen data to the mobile device 22 (e.g., over WiFi or Bluetooth). The mobile device 22 forwards the received screen data to the support center 23 via a network 25 (e.g., the Internet). As a result, the screen data directed to display device 20 can be now viewed by a support center person on a remote station 24. The support center is includes a dedicated software and/or hardware, that will allow to receive the information being transmitted from the mobile device 22, directly to the remote station 24 of the support person, during, and while receiving a phone call (e.g., from a user that needs technical support). Applying software and/or hardware to the support center 23, or to any remote station 24, can be implemented in variety of methods and applications as are well known to a person skilled in the art.

According to an embodiment of the invention, the screen data can be transferred to the mobile device 22 via a wired method or via a local wireless channel based on radio frequency transmission protocol such as WiFi or Bluetooth technology.

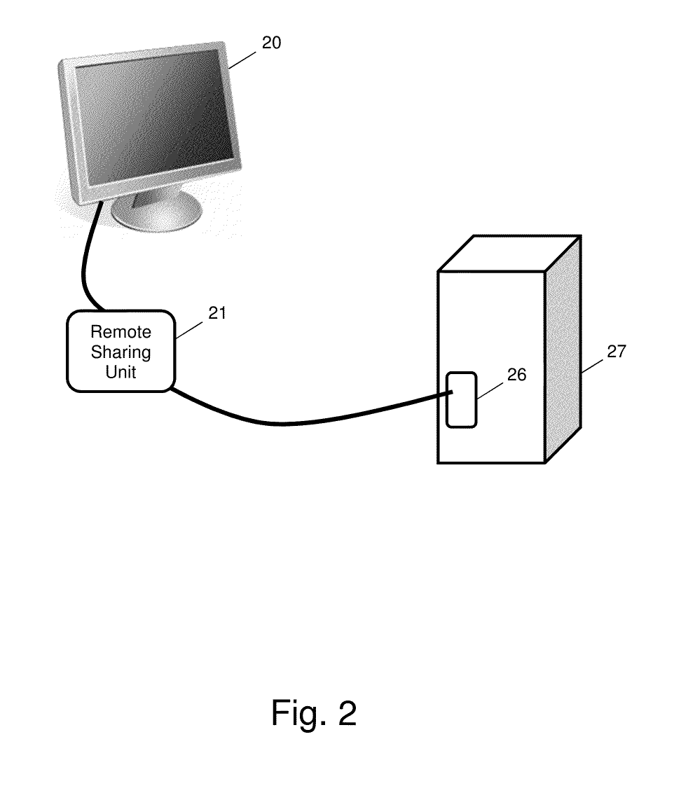

According to an embodiment of the invention, the remote sharing unit 21 acts as a video signals splitter that splits the screen data in one way to the display device 20 and in the other way to the mobile device 22. In such embodiment, the remote sharing unit 21 can be connected in an external manner as a mediating element between the video out connector 26 of a computer system 27 and the display device 20 (as shown in FIG. 2). The remote sharing unit 21 includes a sampling module for capturing the screen data (not shown) and a communication module (not shown) for transferring the captured screen data to the mobile device 22.

According to some embodiments of the invention, the remote sharing unit 21 can be implemented in an internal configuration manner as an integrated part of a display device or as an integrated part of a computer system or graphic adapter. In such internal implementations, the remote sharing unit 21 needs to be connected in such a way that it will be able to capture the screen data being fed to the display device 20.

According to an embodiment of the invention, the mobile device 22 communicates with the remote sharing unit 21 via a dedicated application program resides on the mobile device 22. The dedicated application includes program modules adapted to receive the screen data from the remote sharing unit 21 and to forward the screen data (e.g., to a remote station) upon demand in real-time.

When connecting the remote sharing unit 21 to the display device 20 it will look for signal that will be transmitted, or received, from the dedicated application of the mobile device 22 and will connect the remote sharing unit 21 to the dedicated application.

The dedicated application that resides on the mobile device 22, supports and communicates with the remote sharing unit 21 that is connected to the display device 20. The communication between the dedicated application and the remote sharing unit 21 allows the user, when calling the support center 23, to transmit the current display screen data to the support center 23 during the phone call, or any other communication being established between the user and the support center 23. According to an embodiment of the invention, when calling the support center 23 the person who gives the support will receive in real-time the screen data on the remote station 24, at the same time that he answers the phone call from the user. Using the system of the present invention, in addition to a regular phone conversation between a user and a support person, an automatic screen sharing of the user's computer is also obtained at the same time.

Although the invention described herein in the general context of program modules that execute in conjunction with an application program that runs on an operating system on a mobile device such as a smartphone, those skilled in the art will recognize that the invention may also be implemented in combination with other program modules and computer devices. Generally, program modules include routines, programs, components, data structures, and other types of structures that perform particular tasks or implement particular abstract data types.

As will be appreciated by the skilled person the arrangement described in the figures results in a system that incorporates an application, or any other communication method, that can be applied to the mobile device, and that will allow it to communicate with the remote sharing unit that being connected to the display device (or a computer system) in order to receive the current picture (i.e., screen data) being represented in the display device. In addition the mobile application will allow the user to transmit the current information, with regards to the information that being represented in the screen, during regular phone call, or any other communication method, and will allow the support center person to receive the current information that being represented on the screen, directly and immediately during, and while receiving, the phone call.

Moreover, the system of the present invention allows a support person to view (from a remote location) the represented information in the display device 20 immediately, or during, the phone call and the support process, and therefore saving time for questions, and taking control on the user's computer.

One who read this description, must not consider the author way of expression as fact and must consider the description as a novel process that creates situation of direct communication between the user's display device 20 (or computer system) and the remote station 24 at the support center 23. The process uses the communication equipment and method being applied by the user, e.g., the mobile phone 22, to allow an on line communication between the user's display device 20 and the remote station 24. The support center 23 and the remote sharing unit 21 will know how to communicate with the mobile phone 22, or its relevant application.

With respect to the above description than, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modifications and equivalents may be resorted to, falling within the scope of the invention.

The terms, “for example”, “e.g.”, “optionally”, as used herein, were intended to be used to introduce non-limiting examples. While certain references are made to certain example system components or services, other components and services can be used as well and/or the example components can be combined into fewer components and/or divided into further components.

All the above description and examples have been given for the purpose of illustration and are not intended to limit the invention in any way. Many different computer systems, methods of communications, electronic and logical elements can be employed, all without exceeding the scope of the invention.

1. A system of sharing screen data, comprising: a remote sharing unit adapted to capture screen data generated by a computer system and to communicate with a mobile device for transmitting said captured screen data to the mobile device.

2. A system according to claim 1, further comprising a dedicated application resides on the mobile device that is adapted to communicate with the remote sharing unit and with a remote station, wherein said dedicated application is adapted to receive said screen data and to send said received screen data to the remote station.

3. A system according to claim 2, in which the remote station is adapted to display the screen data received from the mobile device.

4. A system according to claim 3, in which the dedicated application is further adapted to send the received screen data to the remote station during a phone call, or any other communication method, thereby allowing a person operating said remote station to view the screen data as captured by the remote sharing unit at the same time when accepting the phone call and during a phone conversation.

5. A system according to claim 1, in which the remote sharing unit is integrated within a display device.

6. A system according to claim 1, in which the remote sharing unit is integrated within a computer system.

7. A system according to claim 1, in which the remote sharing unit configured to operate as a splitter that receives the screen data in a video input port and splits the received screen data into two video output ports, wherein one output port is adapted to forward the screen data to the display device and the other output port is adapted to transmit the screen data to the mobile device.

8. A system according to claim 1, in which the remote sharing unit and the mobile device communicate via a wired or wireless manner.

9. A method of sharing screen data, comprising:
a) Communicating with a remote sharing unit adapted to capture screen data generated by a computer system; and
b) Receiving screen data transmitted from to the remote sharing unit.

10. A method according to claim 9, further comprising communicating with a remote station for sending the received screen data to the remote station, wherein said remote station is adapted to display said screen data.

11. A method according to claim 9, further comprising allowing sending the screen data to the remote station upon demand.

12. A system, comprising:
a) at least one processor; and
b) a memory comprising computer-readable instructions which when executed by the at least one processor causes the processor to execute a dedicated application, wherein the dedicated application:
communicates with a remote sharing unit operated to transmit screen data;
receives screen data transmitted from said remote sharing unit; and
upon demand, sends the screen data to a remote station.

13. A non-transitory computer-readable medium comprising instructions which when executed by at least one processor causes the processor to perform the method of claim 9.
